(19) United States
(12) Patent Application Publication
(10) Pub. No.: US 2003/0190471 A1
(43) Pub. Date: Oct. 9, 2003

(54) Nanoparticle manganese zinc ferrites synthesized using reverse micelles

(76) Inventors: Evertt Carpenter, Silver Spring, MD (US); Vincent Harris, Laurel, MD (US); Shannon Morrison, Alexandria, VA (US)

Correspondence Address: NAVAL RESEARCH LABORATORY, ASSOCIATE COUNSEL (PATENTS), CODE 1008.2, 4555 OVERLOOK AVENUE, S.W., WASHINGTON, DC, 20375-5320, US

(21) Appl. No.: 10/364,513

(22) Filed: Feb. 12, 2003

Related U.S. Application Data
(60) Provisional application No. 60/370,693, filed on Apr. 9, 2002.

(51) Int. Cl. B32B 5/16; C01G 49/08

(52) U.S. Cl. 428/402; 264/233; 264/235; 252/62.56

(57) ABSTRACT

A method for forming monodispersed magnetic nanoparticles of manganese zinc ferrite is provided which includes reversed micelle synthesis. The method includes preparing a micelle solution of zinc, manganese and iron salts, a surfactant and a hydrocarbon and mixing a second micelle solution of ammonium hydroxide, a surfactant and a hydrocarbon with the first solution to precipitate a ferrite precursor precipitate. The ferrite precursor precipitate is recovered, washed and annealed to produce nanoparticles of manganese zinc ferrite having a spinel crystal structure. Advantageously, the resulting nanoparticles of manganese zinc ferrite have a length no greater than 50 nm in any of the three spatial dimensions and the particle size distribution has a standard deviation of greater than 12% of the mean value.

This application claims the benefit of U.S. Provisional Application No. 60/370,693, filed Apr. 9, 2002.

### FIELD OF THE INVENTION

The present invention relates to manganese zinc ferrite nanoparticles and, in particular, a manganese zinc ferrite nanoparticles synthesized using reverse micelles.

### BACKGROUND OF THE INVENTION

Monodispersed magnetic nanoparticles of manganese zinc ferrite (MZFO) have been synthesized in a variety of methods including hydrothermal processing, mechanical attrition, ceramic processing (i.e., solid state reaction) and a variety of solution chemistry methods. A further prior art method includes using reverse micelle synthesis which makes it possible to form uniform size MZFO particles. With this method, the particle size can be tailored as well as the stoiciometry of the particles.

Currently, there is no reliable method for the synthesis and processing of MnZn-ferrite nanoparticles. In recent years, physical methods such as ball milling and chemical methods like hydrothermal synthesis have shown promise but have fallen short of providing reliable single phase nanoparticles of MnZn ferrite where the size and chemical composition can be controlled. The reverse micelle methods referred to above have been used to synthesize MZFO having a range of compositions from X=0 to 1 with (Mn,Zn)ₓFe_{2-X}O₄, and a crystallite size up to 50 nm diameter.

### SUMMARY OF THE INVENTION

The present invention relates to a process for forming nanoparticles of manganese zinc ferrite. Advantageously, the nanoparticles are monodispersed as a powder sample having a particle size distribution no greater than 12% of the mean value and the nanoparticles typically have a length dimension no greater than 50 nm in any of the three spatial dimensions.

According to one aspect of the present invention, a method is provided for forming monodispersed magnetic nanoparticles of manganese zinc ferrite which includes providing a first micelle solution comprising zinc, manganese and iron metal salts, a first surfactant and a hydrocarbon. A second micelle solution is mixed with the first micelle solution to precipitate a mixed metal hydroxide which is the ferrite precursor. The second micelle solution comprises an alkaline precipitating agent, a second surfactant and a second hydrocarbon. The precursor precipitate is recovered and washed to remove the residual first and second surfactants. A resulting powder is recovered after washing the ferrite precursor and the resulting powder is annealed to produce the nanoparticles of manganese zinc ferrite.

In further alternative embodiments, the first micelle solution comprises metal salts of chloride, nitrate or sulfate, and the first micelle solution and the second micelle solution comprise surfactant selected from, but not limited to, non-ionic surfactants polyethoxylate ethers, anionic sulfate esters, and cationic ammonium salts and a hydrocarbon. Specific examples of surfactants include nonyl phenol ethoxylate and sodium dioctylsulfosuccinate. Specific examples of hydrocarbons include cyclohexane or 2,2,4-trimethylpentane.

In accordance with another aspect of the present invention, a method is provided for forming monodispersed magnetic nanoparticles of manganese zinc ferrite which includes providing a first micelle solution comprising zinc, manganese and iron salts, a first surfactant and a hydrocarbon. The pH of the first micelle solution is adjusted to a pH in the range of 8.0 to 11.0 by adding a second micelle solution comprising aqueous base, a second surfactant, and a second hydrocarbon. The first micelle solution is mixed with the second micelle solution to form a ferrite precursor precipitate. The ferrite precursor precipitate is recovered and washed to remove the residual first and second surfactants. The resulting powder is recovered and annealed at a temperature in the range of 300° C. to 525° C. in an inert gas environment to produce nanoparticles of manganese zinc ferrite having a spinel crystal structure.

In accordance with yet another aspect of the present invention, a composition is provided comprising monodispersed magnetic nanoparticles of manganese zinc ferrite in the form of (MnₓZn₁₋ₓ)_{δ}Fe_{2-δ}O₄ where x≦0 to 1 and δ≦±0.3.

Further features and advantages of the present invention will be set forth in, or apparent from, the detailed description of preferred embodiments thereof which follows.

### DETAILED DESCRIPTION OF THE PREFERRED EMBODIMENTS

As indicated above, the present invention relates to a process for making monodispersed magnetic nanoparticles of manganese zinc ferrite using a reverse micelle method. As was also indicated previously, the particle size distribution advantageously has a standard deviation no greater than 12% of the mean value and the nanoparticles preferably have a length no greater than 50 nm in any of the three spatial dimensions.

The present reverse micelle method includes preparing two micelle solutions. The first micelle solution is an aqueous solution of zinc, manganese and iron salts which include-chloride (CI⁻), nitrate (NO₃⁻), and sulfate (SO₄²⁻). In addition, the first micelle solution includes a surfactant and a hydrocarbon. Examples of surfactants include, but are not limited to, non-ionic surfactants polyethoxylate ethers, anionic sulfate esters, and cationic ammonium salts. Examples of hydrocarbons include, by-are not limited to, cyclohexane or 2,2,4-trimethylpentane. Preferably, the zinc manganese and iron salts are provided in a concentration range of 0.01M to 1.0M aqueous solutions, the surfactant is present in a concentration of 0.1 to 0.5M in a hydrocarbon solvent.

The second micelle solution comprises ammonium hydroxide, a second surfactant, and a hydrocarbon. The second surfactant and second hydrocarbon may be the same as or different from the surfactant and the hydrocarbon of the first micelle solution. Preferably, the concentration range for ammonium hydroxide is 2.0 to 14M aqueous solution; surfactant is present in a concentration of 0.1 to 0.5M in a hydrocarbon solvent.

The pH of the first micelle solution is adjusted by adding the second micelle solution to the first micelle solution to adjust the pH of the first micelle solution to be in the range of 8.0 to 11.0 preferably to a pH of greater than 10.0.

The first micelle solution and second micelle solution are mixed and a ferrite precursor precipitate forms in the first micelle solution. The ferrite precursor precipitate is then recovered from the first micelle solution. This can be done using any conventional recovery method, such as centrifugation, filtration or decanting.

The recovered ferrite precursor is washed to remove the residual surfactant and again to remove counterions and unreacted species. The choice of wash solvents is determined by the solubility of the surfactant. For example, in the case of AOT, the recovered ferrite precursor can be washed with formamide or isooctane to remove the excess surfactant. In the case of NP, a chloroform: methanol mixture can be used to remove the excess surfactant. Once the excess surfactant is removed, unreacted metal species are removed with a methanol/water mixture.

Following the washing of the ferrite precursor, a lower flocculating agent is added to the washed ferrite precursor to disrupt the micelle solution and to allow the resulting powder to precipitate. A resulting powder, i.e. the precipitate, is recovered using standard techniques in the art such as decanting, filtration and centrifugation. In the case of centrifugation, the micelle solution is centrifuged at around 5,000 rpm for five minutes to compact the precipitate and to allow separation of the resulting powder from the dissolved surfactant, unreactive species and hydrocarbons.

The resulting powder is annealed to produce nanoparticles of manganese zinc ferrite. Advantageously, the annealing is conducted at a temperature in the range of 300° C. to 525° C. in a non-oxidizing environment such as under flowing nitrogen gas to complete the transition to nanoparticles of manganese zinc ferrite having a spinel crystal structure without allowing for oxidation to other metal oxides.

The manganese zinc ferrite (MZFO) nanoparticles recovered subsequent to the annealing step consists of manganese zinc ferrites of the general formula (MnₓZn₁₋ₓ)_{δ}Fe_{2-δ}O₄ where x≦0 to 1 and δ≦±0.3. Dynamic light scattering has been used to determine particle size and the results verified using transmission electron microscopy. Composition was determined using inductively coupled plasma. The crystal structure was determined by x-ray powder diffraction and x-ray absorption fine structure measurements. The magnetic properties of these nanoparticles can be measured using a SQUID magnetometer over a temperature range of 5K-300K.

### EXAMPLE

The following example is provided to enhance understanding of the present invention but this example should not be interpreted as limiting the scope of the present invention in any way. In this example, MZFO nanoparticles were produced using the method previously described in which the washed ferrite precursor powder was annealed at 525° C. under flowing nitrogen gas. The resulting nanoparticles had a 22 nm particle diameter as measured by dynamic light scattering. The measured magnetic moment is 64 emu/gram at room temperature compared with that of bulk ceramic MZFO reported in the literature as 65 emu/gram. The magnetization coincides to superparamagnetism and possibly to surface disruption of the magnetic interactions. The magnetization can be increased with suitable packaging of the particles to enhance the interparticle exchange coupling.

Advantages of the present invention are provided by preparing MZFO as nanoparticles in accordance with the invention include reducing conduction losses at high frequency by disrupting eddy current paths. MZFO has the highest magnetic moment of the metal oxides that are useful for applications over dc≦f≦250 MHz and a reduction in conduction losses results in improved performance and an extended frequency range of operation. Nanoparticles having a well-defined particle size distribution also allow for a broader range of packaging, and more specifically, enable packaging as high density compacts, but also as ferrofluids and related slurries.

A further advantage of the present invention is that the nanoparticles of manganese zinc ferrite of the invention have utility with respect to packaging and performance as elements in high frequency devices as well as biomedical applications. Some examples of high frequency devices which may be adapted for using the magnetic nanoparticles of manganese zinc ferrite provided in accordance with the invention include switchable cores, filters, power conversion and power generation and some biomedical applications include MRI contrast agents, cell separation and protein purification.

A further advantage of the present invention provided by the magnetic nanoparticles of manganese zinc ferrite of the invention is that the nanoparticles have improved uniformity and reduced size as compared with prior manganese zinc ferrite nanoparticles. The improved uniformity and reduced size leads to improved packing and performance as previously discussed and further enables use of a lower sintering temperature in processing. For example, particles of the present invention have a sintering temperature of about 500° C. as compared with prior art nanoparticles of manganese zinc ferrite which have a sintering temperature typically greater than 1000° C. In addition, the present invention enables control and tunability of particle size and chemistry as a result of the micelle synthesis provided by the invention.

Although the invention has been described above in relation to preferred embodiments thereof, it will be understood by those skilled in the art that variations and modifications can be effected in these preferred embodiments without departing from the scope and spirit of the invention.

What is claimed is:

1. A method for forming monodispersed magnetic nanoparticles of manganese zinc ferrite, said method comprising the steps of:
providing a first micelle solution comprising zinc, manganese and iron metal salts, a first surfactant, and a hydrocarbon;
mixing a second micelle solution, comprising an alkaline precipitating agent, a second surfactant, and a second hydrocarbon, with the first micelle solution, to form a ferrite precursor precipitate;
recovering the ferrite precursor precipitate;
washing the ferrite precursor precipitate to remove residual surfactant and unreacted species;
recovering a resulting powder after said washing step; and
annealing the resulting powder to produce the nanoparticles of manganese zinc ferrite.

2. The method of claim 1, wherein the metal salts comprising the first micelle solution are selected from the group consisting of chloride, nitrate, and sulfate.

3. The method of claim 1, wherein said first surfactant is selected from the group consisting of non-ionic surfactants polyethoxylate ethers (NP), anionic sulfate esters (AOT), and cationic ammonium salts (CTAB).

4. The method of claim 1, wherein said step of mixing a second micelle solution with the first micelle solution comprises adjusting the pH of the first micelle solution to a pH in the range of 8.0 to 11.0.

5. The method of claim 1, wherein the first hydrocarbon is selected from the group consisting of cyclohexane and 2,2,4-trimethylpentane.

6. The method of claim 1, wherein the second surfactant is selected from the group consisting of non-ionic surfactants polyethoxylate ethers, anionic sulfate esters, and cationic ammonium salts.

7. The method of claim 1, wherein the second hydrocarbon is selected from the group consisting of cyclohexane and 2,2,4-trimethylpentane.

8. The method of claim 1, wherein said step of washing the ferrite precursor comprises washing the ferrite precursor with hydrocarbon, then methanol/water mixture.

9. The method of claim 1, wherein said step of recovering a resulting powder comprises one of:
(i) adding a flocculating agent to the ferrite precursor to disrupt the micelle solution allowing the resulting powder to precipitate; and
decanting the micelle solution to recover the resulting powder;
(ii) adding a flocculating agent to disrupt the micelle solution allowing the resulting powder to precipitate followed by passing the micelle solution over a filter collecting the resulting precipitate; and
(iii) adding a flocculating agent to disrupt the micelle solution, allowing the resulting powder to precipitate, followed by centrifuging at 5000 rpm for 5 minutes to compact the precipitate and allow the separation of the resulting powder from the dissolved surfactant, unreacted species, and hydrocarbons.

10. The method of claim 1, wherein said annealing step comprises annealing the resulting powder at a temperature in the range of 300° C. to 525° C.

11. The method of claim 10, wherein said annealing step is conducted at about 525° C.

12. The method of claim 1, wherein said annealing step further comprises annealing under flowing gas.

13. The method of claim 12, wherein the gas comprises nitrogen or argon.

14. The method of claim 1, wherein said annealing step results in producing magnetic nanoparticles of manganese zinc ferrite with a spinel crystal structure.

15. The method of claim 1, wherein said alkaline precipitating agent is ammonium hydroxide.

16. The method of claim 1, wherein said first surfactant is selected from the group consisting of nonyl phenol ethoxylate (NP) and sodium dioctylsulfosuccinate (AOT).

17. The method of claim 1, wherein said second surfactant is selected from the group consisting of nonyl phenol ethoxylate (NP) and sodium dioctylsulfosuccinate (AOT).

18. The magnetic nanoparticles of manganese zinc ferrite produced according to the method of claim 1.

19. A method for forming monodispersed magnetic nanoparticles of manganese zinc ferrite; said method comprising the steps of:
providing a first micelle solution comprising zinc, manganese and iron metal salts, a first surfactant, and a first hydrocarbon;
adjusting the pH of the first micelle solution to a pH in the range of 8.0 to 11.0 by adding a second micelle solution comprising ammonium hydroxide, a second surfactant, and a second hydrocarbon;
mixing the first micelle solution with the second micelle solution to form a ferrite precursor precipitate;
recovering the ferrite precursor precipitate;
washing the ferrite precursor precipitate to remove residual first surfactant and second surfactant;
recovering a resulting powder after said washing step; and
annealing the resulting powder at a temperature in the range of 300° C. to 525° C. in an inert gas environment to produce the nanoparticles of manganese zinc ferrite having a spinel crystal structure.

20. The magnetic nanoparticles of manganese zinc ferrite produced according to the method of claim 19.

21. A composition comprising:
monodispersed magnetic nanoparticles of manganese zinc ferrite in the form of (MnₓZn₁₋ₓ)_{δ}Fe_{2-δ}O₄ where x≦0 to 1 and δ≦±0.3.

22. The composition of claim 21, wherein said monodispersed magnetic nanoparticles of manganese zinc ferrite has a particle size distribution where the standard deviation is no greater than 12% of a mean value.

23. The composition of claim 21, wherein said nanoparticles have a mean particle diameter of less than 50 nm.
